(19) United States
(12) Patent Application Publication
(10) Pub. No.: US 2005/0229976 A1
(43) Pub. Date: Oct. 20, 2005

(54) Adjustable rinse flow in semiconductor processing

(76) Inventors: Yao-Hwan Kao, Baoshan Town Ship (TW); Huei-Yi Chang, Taipei City (TW)

Correspondence Address: DUANE MORRIS LLP;IP DEPARTMENT (TSMC), 4200 ONE LIBERTY PLACE, PHILADELPHIA, PA, 19103-7396, US

(21) Appl. No.: 10/826,054

(22) Filed: Apr. 16, 2004

(51) Int. Cl. F16K 31/365

(52) U.S. Cl. 137/501

(57) ABSTRACT

In the manufacture of semiconductor devices, a system and method for delivering gas at a predetermined rate of flow is disclosed, which includes: a flow controller having a diaphragm forming upstream and downstream chambers; a regulator for delivering gas to the upstream chamber of the flow controller at a substantially constant pressure, the controller having an outlet from the downstream chamber which is opened and closed by the diaphragm; an urging means for urging the diaphragm toward its closed position; and a valve for selectively adjusting the spring force to achieve the predetermined rate of flow without having to use a gas flow measurement device to monitor the flow rate.

### FIELD OF THE INVENTION

This invention pertains generally to the control of the flow of gas in semiconductor device manufacture and processing, and more particularly, to a system which includes an improved diaphragm type gas flow controller.

### BACKGROUND OF THE INVENTION

The precise delivery of gas, or the gas flow rate (volume per unit time), is critical to the operation of many laboratory instruments such as gas chromatographs, gas calibration units, and headspace sampling systems. Perhaps the most simple method of adjusting gas flow is by holding the upstream pressure constant against a variable orifice in the gas stream, for example, a needle valve or other type of metering valve, or conversely, changing the upstream pressure against a fixed restriction in the gas stream. If, however, the downstream pressure varies due to changes in downstream restriction or temperature, the gas flow will not remain constant.

Various types of flow controllers have been developed to compensate for changes in downstream pressure by maintaining a constant differential pressure across a restriction integral to the controller, or by sensing changes in gas flow and operating a metering valve in the gas stream to compensate for these changes, thereby sustaining a constant flow rate. There are presently three major methods for maintaining constant gas flow for instrumentation.

One of the oldest devices is the diaphragm flow controller, where upstream and downstream pressure exert an opposing force on a diaphragm. Movement of the diaphragm under these forces opens and closes a valve or nozzle, whose reference position is established by a spring force. Supplying the gas to the downstream sides of the diaphragm establishes a differential pressure across an orifice or restriction in the gas path, between the upstream and downstream sides of the diaphragm. If the downstream pressure rises, the diaphragm will move against the spring force until the pre-set differential pressure is reestablished. This gas control method is quite robust and stable over time, but is dependent on a constant upstream gas pressure.

The second type of apparatus for maintaining a constant gas flow is the mass flow controller, where gas flow is sensed by the transfer of heat from an electrically heated element to another element which is part of a resistance bridge, or in an even simpler version, where a resistive element changes temperature under the influence of a flowing gas removing heat from that element. In either case, the sensed change in gas flow can, with appropriate amplification of the electrical signal, be used to open or close an electrically operated valve or restrictor to maintain constant gas flow against upstream or downstream changes in gas pressure.

A third apparatus for maintaining a constant gas flow utilizes an electrical sensor to determine the differential pressure across an orifice and to adjust the orifice or valve to deliver a pre-set differential pressure. Because gas flow is proportional to the square root of differential pressure across an orifice or restriction (by Bernoulli's equation), such a device can be utilized with appropriate factors for individual gases to translate differential pressure directly into gas flow.

These last two methods for controlling gas flow are capable of not only controlling the gas flow, but also of yielding an electrical signal that may be used to indicate the magnitude of the gas flow. On the other hand, the diaphragm controller must utilize an external device to measure the gas flow which is set by the spring force against the diaphragm. This force could, of course, be supplied by a load cell integral to the diaphragm controller and the electrical signal could thus be translated by appropriate circuitry into an indication of flow rate. In practice, however, most users of diaphragm flow controllers measure the gas flow with such devices as turbine meters, soap film meters, or the like.

An advantage of the diaphragm flow controller not shared by the other two devices is the robust character of a strictly mechanical device. However, the devices used to measure the gas flow, such as the bubble meter and mass flow meter, tend to be inaccurate primarily because they require constant recalibration.

The mass flow controller and the differential pressure sensor, although not requiring gas flow measurement devices, tend also to drift away from accurate calibration due to changes in the electrical characteristics of the sensors with time. A common fault in all three gas flow controllers is the recalibration required each time a different type of gas is monitored, or the monitoring conditions vary.

In the manufacture and processing of semiconductor devices, a need exists to provide precise, adjustable rinse flow depending on whether a poly layer, well, or other hole layer is in need of treatment. Therefore, it is an object of the present invention to provide a system having a diaphragm type gas flow controller that does not require constant recalibration or the use of external gas flow measurement devices, is impervious to both the upstream and downstream pressure changes, and automatically accommodates changes in the gas flow being controlled.

### SUMMARY OF THE INVENTION

These and other features are accomplished, in accordance with the embodiment of this invention, by a system for delivering gas at a predetermined rate of flow in the processing of semiconductor devices, which includes a flow controller having a diaphragm forming upstream and downstream chambers connected by a fixed orifice and means for delivering gas at a substantially constant pressure to the upstream chamber of the flow controller. A heating element maintains the gas in the system at a substantially constant temperature. An outlet from the downstream chamber of the flow controller is opened and closed by the diaphragm, which is urged to the closed position by an urging means. The force of the urging means is selectively adjusted to achieve the predetermined rate of flow without having to use a gas flow measurement device to monitor the flow rate. Additional details regarding the system are found in U.S. Pat. No. 5,329,966, herein incorporated by reference. Note that the term “urging means” may include e.g., springs, recoils, or any other such devices that achieve the same or substantially the same results as a spring.

### BRIEF DESCRIPTION OF THE DRAWINGS

FIG. 1 is a cross-sectional view of a suitable gas flow controller.

### DESCRIPTION OF THE PREFERRED EMBODIMENTS

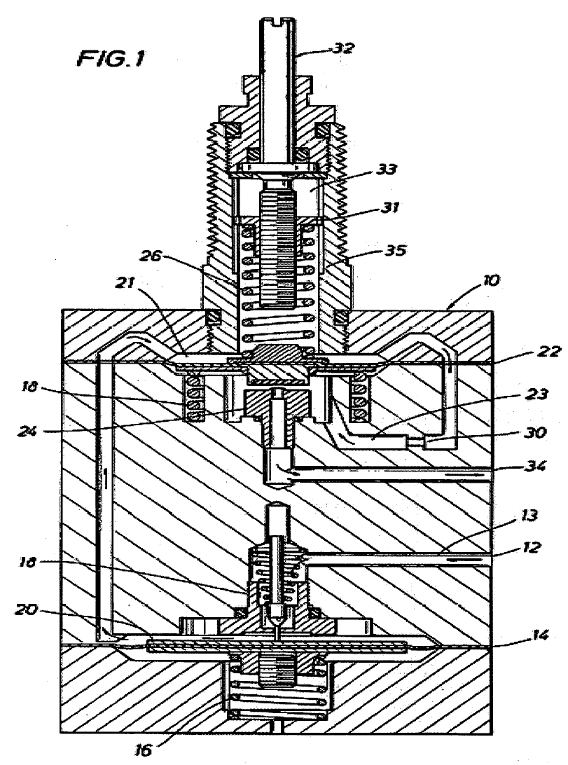

Now referring to FIG. 1, the gas flow controller for the preferred embodiment of this invention is illustrated generally as 10. A gas to be controlled is pumped in at inlet 12 and follows the flow path designated by the arrows. The gas is first passed through a diaphragm type pressure regulator consisting of diaphragm 14 forming inlet chamber 13 and outlet chamber 20, pressure regulator spring 16, and poppet valve 18. Pressure regulator spring 16 applies a fixed spring force against diaphragm 14 which in turn operates poppet valve 18 to produce a constant pressure on the gas in outlet chamber 20.

The gas in outlet chamber 20 is connected with upstream chamber 21 of a diaphragm flow controller which is contained in a single housing with the diaphragm type pressure regulator making one single unit. This diaphragm type flow controller operates in the same manner as a typical diaphragm flow controller, where upstream and downstream pressure exert an opposing force on diaphragm 22 that defines upstream chamber 21 and downstream chamber 23. Movement of diaphragm 22 under the forces opens and closes nozzle 24, supplying gas to outlet 34 from the downstream chamber 23. Bias spring 26 and differential spring 28 are located on the upstream and downstream sides of the diaphragm, respectively, to establish differential pressure across orifice 30 in the gas path between upstream chamber 21 and downstream chamber 23 of diaphragm 22. Operator stem 32 is rotated forcing antirotation flange 31 to travel within cavity 33 to apply a liner displacement force on bias spring 26 to adjust the flow controller to establish a predetermined pressure of the gas flowing through outlet 34. If the downstream pressure rises, the diaphragm 22 will move against the spring force until the predetermined differential pressure is reestablished.

Any upstream pressure greater than pressure produced by the spring force from bias spring 26 will then have little or no effect on the gas flow produced by the flow controller. Gas flow is, thus, immune to both upstream and downstream pressure changes within the following limits. The inlet pressure must be greater than that produced by the pressure regulator spring force, and downstream pressure must be less than that supplied by the pressure regulator minus the highest differential pressure produced by the flow controller.

In an embodiment of this invention, the means for delivering gas at a constant pressure is a regulator having a diaphragm forming an inlet chamber for receiving gas at a given pressure and an outlet chamber connecting with the upstream chamber of the flow controller and adapted to be opened and closed by the diaphragm. The regulator also includes spring means urging the diaphragm toward a closed position with a fixed force. The flow controller and said regulator are contained in a single housing surrounded by the heating element. The means for selectively adjusting the spring force means includes a stem (needle valve) rotatable in opposite directions to adjust the spring force, means for determining a rotative position of the stem representative of a reference point, and means for rotating the stem to another position with respect to the reference point which is representative of the predetermined rate of flow. In an additional embodiment, at least one fin flow sensor is present, which monitors the rate of flow.

A stepper motor is utilized in conjunction with a microprocessor that is used to determine a number of steps that are employed to rotate the stem to achieve the predetermined rate of flow for the gas being controlled, and to actuate said stepper motor to take the number of steps from a predetermined reference point. An optical encoder including an optical pickup and a single slot encoder disk connected to the stem, is monitored by the microprocessor to determine the reference point.

The combination of the diaphragm type flow controller and a diaphragm type pressure regulator into a single unit, adjusted by a microprocessor controlled stepper motor, creates a gas flow controller which does not require constant recalibration, nor a constant external monitoring of the flow rate of the gas into or out of the flow controller.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

1. In the processing of semiconductor devices, a system for delivering gas at a predetermined rate of flow, comprising: a flow controller having a diaphragm forming upstream and downstream chambers; a regulator for delivering gas to the upstream chamber of the flow controller at a substantially constant pressure, said controller having an outlet from the downstream chamber which is opened and closed by the diaphragm; an urging means for urging the diaphragm toward its closed position; and a valve for selectively adjusting the spring force to achieve the predetermined rate of flow without having to use a gas flow measurement device to monitor the flow rate.

2. The system as recited in claim 1, wherein said controller and said regulator are contained in a single housing.

3. The system as recited in claim 1, additionally comprising a heating element for maintaining the gas in said system at a substantially constant temperature.

4. The system as recited in claim 1, wherein the valve includes a stepper motor.

5. The system as recited in claim 1, wherein the urging means is a spring.

6. In the processing of semiconductor devices, a method for delivering gas at a predetermined rate of flow, comprising: regulating the delivery of gas to an upstream chamber of a flow controller at a substantially constant pressure, said controller having an outlet from a downstream chamber which is opened and closed by a diaphragm; and selectively adjusting spring force to achieve the predetermined rate of flow without having to use a gas flow measurement device to monitor the flow rate.

7. The method as recited in claim 6, wherein said controller is contained in a single housing with a pressure regulator.

8. The method as recited in claim 6, wherein the gas in said system is maintained at a substantially constant temperature.
